(19) United States
(12) Patent Application Publication
(10) Pub. No.: US 2026/0307907 A1
(43) Pub. Date: Oct. 8, 2026

(54) CONVEYANCE BELT AND POWER TRANSMISSION BELT

(71) Applicant: NITTA CORPORATION, Osaka-shi, Osaka (JP)

(72) Inventors: Akito OI, Yamatokoriyama-shi, Nara (JP); Koki MORIMOTO, Yamatokoriyama-shi, Nara (JP); Yuta SUZUKI, Yamatokoriyama-shi, Nara (JP); Hayate NAITO, Yamatokoriyama-shi, Nara (JP)

(21) Appl. No.: 19/480,433

(22) PCT Filed: Apr. 26, 2024
(86) PCT No.: PCT/JP2024/016418

§ 371 Date: Oct. 31, 2025

(30) Foreign Application Priority Data
May 2, 2023 (JP) 2023-076193

(51) Int. Cl. B65G 15/34; F16G 1/14

(52) U.S. Cl. CPC B65G 15/34; F16G 1/14; B65G 2812/02198

(57) ABSTRACT

A conveyance belt that does not harden even in a low-temperature environment of −30 °C or lower, is capable of reducing a possibility of damage to a motor and a pulley in a conveyance facility, and is capable of stably conveying an object to be conveyed, and a power transmission belt that is capable of reducing a possibility of damage to a motor and a pulley in a power facility are provided. A conveyance belt 10 has conductivity, and the conveyance belt 10 includes a belt body 12 made of a thermoplastic resin having a durometer hardness A of 85 or less as specified in JIS K7311 at −30 °C. The conveyance belt 10 does not harden even in a low-temperature environment of −30 °C or lower, and is capable of reducing a possibility of damage to a motor and a pulley in a conveyance facility, and is capable of stably conveying an object to be conveyed.

### TECHNICAL FIELD

The present invention relates to a conveyance belt and a power transmission belt.

### BACKGROUND ART

A conveyance belt is used to convey objects to be conveyed such as various objects or cardboard boxes containing objects. A belt using a resin such as a thermoplastic elastomer is known as such a conveyance belt, and is used to prevent scratches on various objects to be conveyed during conveying (see, for example, Patent Literatures 1, 2, 3, and 4).

### CITATION LIST

### Patent Literature

Patent Literature 1: JP2021-134038A
Patent Literature 2: JP2004-347054A
Patent Literature 3: JP2004-347111A
Patent Literature 4: JP2021-104875A

### SUMMARY OF INVENTION

### Technical Problem

However, when a conveyance belt made of a resin is used in a low-temperature environment of −30 °C or lower, the resin material of the conveyance belt hardens and loses flexibility, and thus there is a problem that the conveyance belt is damaged. Even if the conveyance belt is not damaged, the loss of flexibility may increase a load on a motor and a pulley of a conveyance facility on which the conveyance belt is stretched, and these components may be damaged. Furthermore, there is a problem that in the low-temperature environment of −30 °C or lower, a coefficient of friction of a conveying surface of the conveyance belt decreases, and thus a gripping property between an object to be conveyed and the conveying surface of the conveyance belt is reduced, making it difficult to convey the object to be conveyed stably.

Therefore, in the low-temperature environment of −30 °C or lower in the related art, conveyance must be performed using a chain, a steel belt, a metal roller, or the like, and thus the conveyance facility becomes larger and heavier, and it is difficult to say that efficient conveyance can be performed.

Similarly, in a power transmission belt that transmits power to a motor or a pulley in a power facility, when the power transmission belt made of a resin is used in the low-temperature environment of −30 °C or lower, the resin material of the power transmission belt hardens and loses flexibility, and thus there is a problem that the power transmission belt is damaged. Even if the power transmission belt is not damaged, the loss of flexibility may increase a load on a motor and a pulley of the power facility on which the power transmission belt is stretched, and there is a problem that these components may be damaged.

An object of the present invention is to provide a conveyance belt that does not harden even in a low-temperature environment of −30 °C or lower, is capable of reducing a possibility of damage to a motor and a pulley in a conveyance facility, and is capable of stably conveying an object to be conveyed.

In addition, an object is to provide a power transmission belt that does not harden even in a low-temperature environment of −30 °C or lower, and is capable of reducing a possibility of damage to a motor and a pulley in a power facility.

### Solution to Problem

A conveyance belt of the present invention relates to a conveyance belt having conductivity, and includes a belt body made of a thermoplastic resin having a durometer hardness A of 85 or less as specified in JIS K7311 at −30 °C.

A power transmission belt according to the present invention relates to a power transmission belt having conductivity, and includes a belt body made of a thermoplastic resin having a durometer hardness A of 85 or less as specified in JIS K7311 at −30 °C

### Advantageous Effects of Invention

According to the present invention, since the belt body has a durometer hardness A of 85 or less at −30 °C, flexibility can be maintained without hardening even in a low-temperature environment of −30 °C or lower, a possibility of damage to a motor and a pulley of a conveyance facility can be reduced, and an object to be conveyed can be conveyed stably.

Since the belt body of the present invention has a durometer hardness A of 85 or less at −30 °C, flexibility can be maintained without hardening even in a low-temperature environment of −30 °C or lower, and a possibility of damage to a motor and a pulley of a power facility can be reduced.

### BRIEF DESCRIPTION OF DRAWINGS

FIG. 1 is a cross-sectional view showing a configuration of a conveyance belt according to an embodiment of the present invention.

FIG. 2 is a schematic diagram showing a tensile force and a compressive force acting on the conveyance belt according to the embodiment.

FIG. 3 is a cross-sectional view showing a configuration of a conveyance belt according to a second embodiment in which a surface roughness Rz specified in JIS B0601 of a conveying surface of a belt body is more than 100 μm.

FIG. 4 is a cross-sectional view showing a configuration of a conveyance belt according to a third embodiment which includes a front surface layer, a conductive resin layer, and a belt body.

FIG. 5 is a cross-sectional view showing a configuration of a conveyance belt according to a fourth embodiment which includes a belt body, a knitted fabric, and a conductive resin layer.

FIG. 6 is a cross-sectional view showing a configuration of a conveyance belt according to a fifth embodiment which includes a front surface layer, a conductive resin layer, a belt body, and a knitted fabric.

FIG. 7 is a cross-sectional view showing a configuration of a conveyance belt according to another embodiment which includes a front surface layer, a conductive resin layer, a belt body, a knitted fabric, and a back surface layer.

FIG. 8 is a cross-sectional view showing a configuration of a conveyance belt according to a sixth embodiment in which a vertical groove is provided on a conveying surface of a front surface layer along a longitudinal direction.

FIG. 9 is a cross-sectional view showing a configuration of a conveyance belt according to a seventh embodiment which includes a knitted fabric, a belt body, and a conductive resin layer.

### DESCRIPTION OF EMBODIMENTS

### First Embodiment

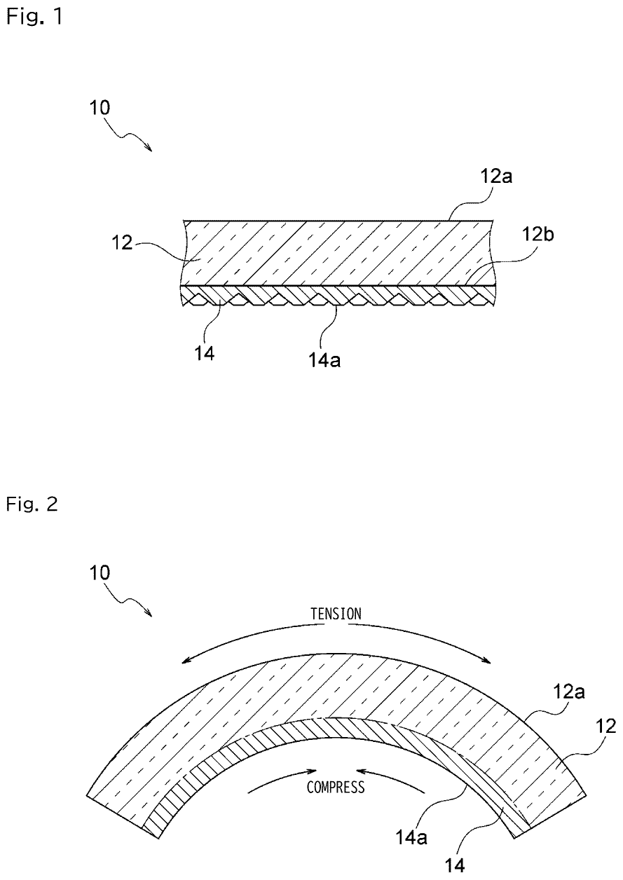

Hereinafter, embodiments of the present invention will be described. In the following description, the same components as those described above are denoted by the same reference numerals, and the description thereof will be omitted. FIG. 1 shows a conveyance belt 10 according to the present embodiment. The conveyance belt 10 includes a belt body 12 and a conductive resin layer 14. A thickness of the conveyance belt 10 is desired to be 0.9 mm or more and 2.0 mm or less. Considering a conveying capacity for an object to be conveyed, the thickness of the conveyance belt 10 is more preferably 1.0 mm or more and 1.6 mm or less.

The belt body 12 is formed from a thermoplastic resin having a glass transition temperature of −30 °C or lower, such as an ether-based thermoplastic polyurethane resin. The thermoplastic resin of the belt body 12 preferably has a durometer hardness A of 85 or less as specified in JIS K7311 at −30 °C, and more preferably has a durometer hardness A of 75 or more and 79 or less. This durometer hardness A is an index indicating a hardness of rubber, thermoplastic elastomers, and the like, and is measured using a durometer type A in JIS K7311. If the belt body 12 has a durometer hardness A of 85 or less at −30 °C, hardening does not occur even in a low-temperature environment of −30 °C. Therefore, the conveyance belt 10 does not harden even in the low-temperature environment of −30 °C, a possibility of damage to a motor and a pulley of a conveyance facility around which the conveyance belt 10 is wound is reduced, and an object to be conveyed can be stably conveyed.

Meanwhile, the belt body 12 preferably has the durometer hardness A of 75 or more at 23 °C, which corresponds to room temperature. If the durometer hardness A at 23 °C is less than 75, the belt body 12 becomes too soft at room temperature, and tensile strength of the conveyance belt 10 is reduced. The tensile strength of the belt body 12 in the low-temperature environment of −30 °C is preferably less than 50% of the tensile strength in a room-temperature environment of 23 °C. The tensile strength can be measured using a tensile tester including a thermostatic chamber that can be adjusted to be an environment of −30 °C. A measurement method involves grasping a top and a bottom of the belt in the longitudinal direction, stretching the belt at a specific stretching rate, and measuring tension after leaving the belt for 30 minutes. The stretching rate during the test is preferably a stretching rate actually used. An example of a thermoplastic resin capable of producing the belt body 12 satisfying such performance may include Pandex T-8375 (registered trademark, manufactured by DIC Co., Ltd.), which is an ether-based thermoplastic polyurethane resin. A color of a resin constituting the belt body 12 is not particularly limited, and may be a transparent color or an opaque color.

One surface of the belt body 12 serves as a conveying surface 12a on which an object or the like is placed. The conveying surface 12a preferably has a surface roughness Rz as specified in JIS B0601 of 15 μm or more and 100 μm or less, and more preferably 20 μm or more and 50 μm or less. Here, the surface roughness Rz refers to a 10-point average roughness described in JIS B0601, and the surface roughness can be measured, for example, using HANDYSURF (product name: manufactured by TOKYO SEIMITSU Co., Ltd.) . If the surface roughness Rz is more than 100 μm, irregularities of the conveying surface 12a become too large, making it more likely to cause cracks or the like in the belt body 12 in the low-temperature environment of −30 °C. If the surface roughness Rz is less than 15 μm, a coefficient of friction of the conveying surface 12a becomes small, and a conveying efficiency of the object to be conveyed may be reduced.

The conductive resin layer 14 is laminated on a surface 12b opposite to the conveying surface 12a of the belt body 12, and is provided to impart an antistatic effect to the conveyance belt 10. The conductive resin layer 14 is a resin layer formed, for example, in black and conductive by containing a conductive filler in the resin. In the present embodiment, the conductive resin layer 14 is formed by blending carbon black with thermoplastic polyurethane. A back surface 14a of the conductive resin layer 14 (a surface opposite the belt body 12) that comes into contact with a pulley has small irregularities to increase friction force with the pulley. A surface roughness Rz of the back surface 14a of the conductive resin layer 14 is equal to or larger than that of the conveying surface 12a. Note that FIG. 1 shows an example in which the surface roughness Rz of the back surface 14a of the conductive resin layer 14 is larger than that of the conveying surface 12a.

The resin constituting the conductive resin layer 14 is not particularly limited as long as the resin has abrasion resistance and elasticity, and for example, polyurethane, vulcanized rubber, and polyester elastomer may be used. It is preferable to use thermoplastic resins for the belt body 12 and the conductive resin layer 14 from a viewpoint of ease of manufacturing and ease of joining the conveyance belt 10 when forming an endless belt.

The conductive filler is not particularly limited as long as the conductive filler can be blended with the resin to impart conductivity, and for example, carbon-based components such as carbon black, carbon nanotubes, carbon fibers, and graphite, as well as oxides such as those of iron or copper may be used. A carbon-based conductive filler is particularly preferred due to high conductivity. A surface electrical resistance of the conductive resin layer 14 is preferably 10⁹ Ω/□ or less.

As long as the above conductive resin layer 14 has conductivity, the color or thickness of the conductive resin layer 14 is not limited, and for example, the conductive resin layer 14 may be formed thinner than the belt body 12. For example, if the thickness of the belt body 12 is 1.0 mm, the thickness of the conductive resin layer 14 is approximately 0.05 mm (0.2 mm if irregularities on the surface are included).

The conveyance belt 10 having the above configuration has both ends joined to form an endless belt, and is used by being stretched between, for example, a drive pulley and a driven pulley. In this case, the conveyance belt 10 is stretched such that the back surface 14a of the conductive resin layer 14 is in contact with the pulley, and the conveying surface 12a of the belt body 12 is disposed on an outer side of the pulley in a radial direction. Therefore, as shown in FIG. 2, a force (compressive force) in a compression direction acts on the back surface 14a of the conductive resin layer 14, and a force (tensile force) in a tensile direction acts on the conveying surface 12a of the belt body 12. The conveyance belt 10 conveys an object to be conveyed in a running direction by running, for example, with the object to be conveyed placed on the conveying surface 12a. Note that by causing the conveyance belt 10 to run with the object to be conveyed sandwiched between the conveyance belt 10 and a conveying surface of another conveyance belt running parallel to the conveyance belt 10, the object to be conveyed may be conveyed.

The conveyance belt 10 can be manufactured by any method as long as this method does not cause the belt body 12 and the conductive resin layer 14 to separate from each other. For example, when the conveyance belt is manufactured by extrusion lamination, a mixture in which a conductive filler is blended in a molten resin is spread onto, for example, a fabric (or release paper) having a release-treated surface to form the conductive resin layer 14. A raw material for the belt body 12 is melted and extruded into a film shape from an extruder onto the surface of the conductive resin layer 14 on the fabric, and then fed to a cooling roller for lamination. A laminate thus formed in which the belt body 12 and the conductive resin layer 14 are integrated is peeled off from the fabric to form the conveyance belt 10.

In the present embodiment, a method of imparting conductivity to the conveyance belt 10 is to laminate the conductive resin layer 14 onto the belt body 12, but the present invention is not limited thereto. For example, a conveyance belt having conductivity may be obtained by embedding knit (knitted fabric) using a conductive yarn inside the belt body 12 or by laminating the knit on the surface of the belt body 12. In addition, an ion conducting material can be mixed into the thermoplastic resin of the belt body 12 to provide a conveyance belt having conductivity, and such a configuration can also impart an antistatic effect to the conveyance belt.

According to the present embodiment, since the belt body 12 has the durometer hardness A of 85 or less at −30 °C, flexibility can be maintained without hardening even in the low-temperature environment of −30 °C or lower, and a possibility of damage to a motor and a pulley of a conveyance facility can be reduced, and an object to be conveyed can be conveyed stably. The conveyance belt 10 of the present embodiment, which uses the above Pandex T-8375 for the belt body 12, is stretched around a pulley with a diameter (φ) of 25 mm and subjected to a running test in an environment of −30 °C or lower, and it can be confirmed that the conveyance belt 10 does not harden or break even after running more than 10 million times, and that the motor and the pulley of the conveying facility are not damaged. In addition, it can be confirmed that by setting the conveying surface 12a of the belt body 12 to 15 um or more and 100 um or less, the object to be conveyed can be gripped and accurately conveyed even when the object to be conveyed is placed on the conveying surface 12a.

### Second Embodiment

In the above embodiment, the surface roughness Rz specified in JIS B0601 of the conveying surface 12a of the belt body 12 is set to 15 μm or more and 100 μm or less, but the present invention is not limited thereto. The surface roughness Rz specified in JIS B0601 of the conveying surface of the belt body 12 may be more than 100 μm and 1000 μm or less. By increasing the surface roughness Rz of the conveying surface of the belt body 12 to more than 100 μm (high-μ), even in a conveying facility that performs inclined conveyance for conveying an object to be conveyed in an inclined state, or in a conveying facility that repeatedly starts and stops a motor, the object to be conveyed can be held on the conveying surface without moving, even if an external force is applied to the object to be conveyed at the time of the inclined conveyance and at the time of starting or stopping the motor.

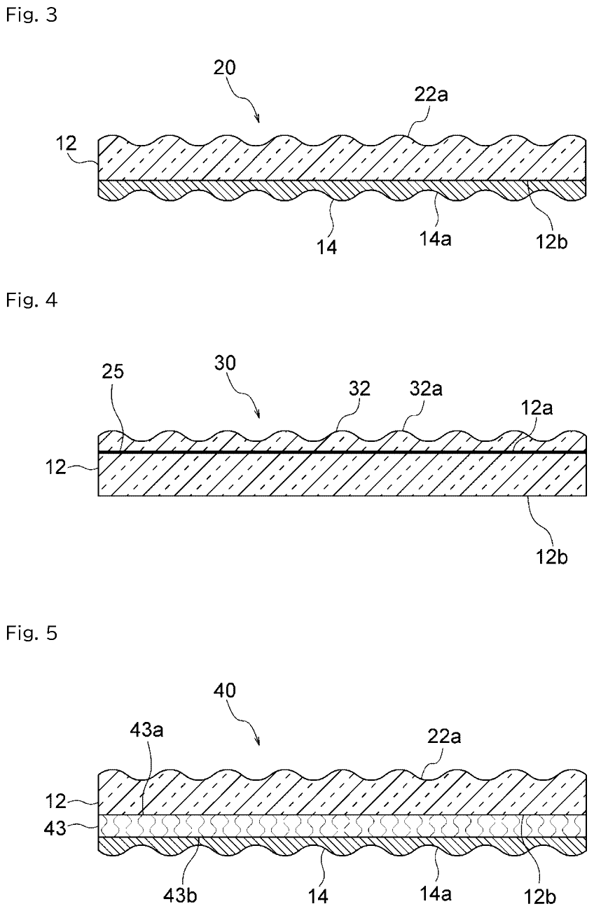

FIG. 3 is a cross-sectional view showing a configuration of a conveyance belt 20 according to a second embodiment in which a surface roughness Rz specified in JIS B0601 of a conveying surface 22a of the belt body 12 is more than 100 μm. In this case, irregularities in which the surface roughness Rz specified in JIS B0601 may be more than 100 μm and 1000 μm or less are formed on the conveying surface 22a of the belt body 12. For example, the irregularities of the belt body 12 can be formed by transferring irregularities with a predetermined surface roughness Rz to the conveying surface 22a by a roll or by a canvas for weight processing having predetermined irregularities.

In the conveyance belt 20, a surface roughness Rz specified in JIS B0601 of the conveying surface 22a of the belt body 12 is set to more than 100 μm, so that the coefficient of friction can be improved, and the object to be conveyed is difficult to slip on the conveying surface 22a and can be held on the conveying surface 22a even during the inclined conveyance or conveyance that involves repeated start-and-stop operations.

According to the above configuration, the conveyance belt 20 according to the second embodiment, similar to the first embodiment described above, can maintain the flexibility without hardening even in the low-temperature environment of −30 °C or lower, and the possibility of damage to the t motor and the pulley of the conveying facility can be reduced, and the object to be conveyed can be stably conveyed. Further, by making the conveying surface 22a of the belt body 12 of the conveyance belt 20 have a surface roughness Rz of more than 100 μm and 1000 μm or less, the coefficient of friction is improved, and the gripping property is further provided. Therefore, the conveyance belt 20 can prevent the object to be conveyed from slipping on the conveying surface 22a and can reliably convey the object to be conveyed, even during the inclined conveyance in the low-temperature environment of −30 °C or lower or during conveyances that require repeated start-and-stop operations in the low-temperature environment of −30 °C or lower.

### Third Embodiment

In the second embodiment described above, the surface 22a, exposed to the outside, of the belt body 12 has the surface roughness Rz specified in JIS B0601 of more than 100 μm and 1000 μm or less, but the present invention is not limited thereto, and as shown in FIG. 4, a conveyance belt 30 may also be provided in which a front surface layer 32 having a conveying surface 32a having a surface roughness Rz specified in JIS B0601 of more than 100 μm and 1000 μm or less is provided separately from the belt body 12. The front surface layer 32 provided as an upper layer of the belt body 12 is desired to be formed from the same material as the belt body 12 (a thermoplastic resin having a glass transition temperature of −30 °C or lower, such as an ether-based thermoplastic polyurethane resin). In this case, a conductive resin layer 25 made of the same conductive resin as the conductive resin layer 14 (FIG. 1) is provided on the surface 12a of the belt body 12, and the front surface layer 32 is provided on the conductive resin layer 25. In the conveyance belt 30, the back surface 12b of the belt body 12 is exposed to the outside and the back surface 12b is in contact with the pulley. Note that the conductive resin layer 25 is a resin layer made conductive by, for example, containing a conductive filler in the resin. The resin that constitutes the conductive resin layer 25 is not particularly limited as long as the resin has abrasion resistance and elasticity, and for example, polyurethane, vulcanized rubber, and polyester elastomer may also be used.

According to the above configuration, the conveyance belt 30 according to a third embodiment can exert the same effects as those in the above first embodiment. By making the conveying surface 32a of the front surface layer 32 of the conveyance belt 30 have a surface roughness Rz of more than 100 μm and 1000 μm or less, the coefficient of friction is improved, and the gripping property can be further provided.

### Fourth Embodiment

FIG. 5 is a cross-sectional view showing a configuration of a conveyance belt 40 according to a fourth embodiment which includes the belt body 12, a knitted fabric (knit) 43, and the conductive resin layer 14. The conveyance belt 40 according to the fourth embodiment has a feature of including the knitted fabric 43. In this case, the knitted fabric 43 has the belt body 12 provided on a front surface 43a of the knitted fabric 43, and the conductive resin layer 14 provided on a back surface 43b of the knitted fabric 43. Unlike canvas which has no stretchability, the knitted fabric 43 has stretchability. Therefore, unlike a conveyance belt using canvas, the conveyance belt 40 including the knitted fabric 43 provided on the back surface 12b of the belt body 12 can be an elastic belt that has the stretchability due to the knitted fabric 43 and the elasticity due to the belt body 12, and can be used as an endless belt without a tension mechanism.

The knitted fabric 43 according to the present embodiment may be made conductive by using a conductive yarn. However, since the conductive resin layer 14 is separately provided in the present embodiment, the knitted fabric 43 may be made non-conductive by using a non-conductive yarn. In addition, warp yarns of the knitted fabric 43 are desired to be multifilament. Weft yarns of the knitted fabric 43 are desired to be monofilament or multifilament. The knitted fabric 43 is desired to have the warp yarns arranged along the longitudinal direction, which is a conveying direction of the conveyance belt 40, and the weft yarns arranged along a belt width direction, which is perpendicular to the longitudinal direction.

Note that FIG. 5 shows a case where the surface roughness Rz specified in JIS B0601 of the conveying surface 22a, exposed to the outside, of the belt body 12 is more than 100 μm and 1000 μm or less, but the present invention is not limited thereto, and the surface roughness Rz specified in JIS B0601 may be 100 μm or less.

The conveyance belt 40 can be manufactured by any method as long as this method does not cause the belt body 12, the knitted fabric 43, and the conductive resin layer 14 to separate from each other. For example, the knitted fabric 43 is placed on a fabric subjected to a conduction process, and then the resin for forming the belt body 12 is extruded and bonded under heating and pressurizing conditions on the knitted fabric 43 to manufacture the conveyance belt 40. The irregularities having a predetermined surface roughness Rz are formed on the conveying surface 22a of the belt body 12 by a canvas for texture processing having predetermined irregularities or by a roll.

According to the above configuration, the conveyance belt 40 according to the fourth embodiment can exert the Same effects as those in the above first embodiment, and the stretchability due to the knitted fabric 43 can also be provided.

### Fifth Embodiment

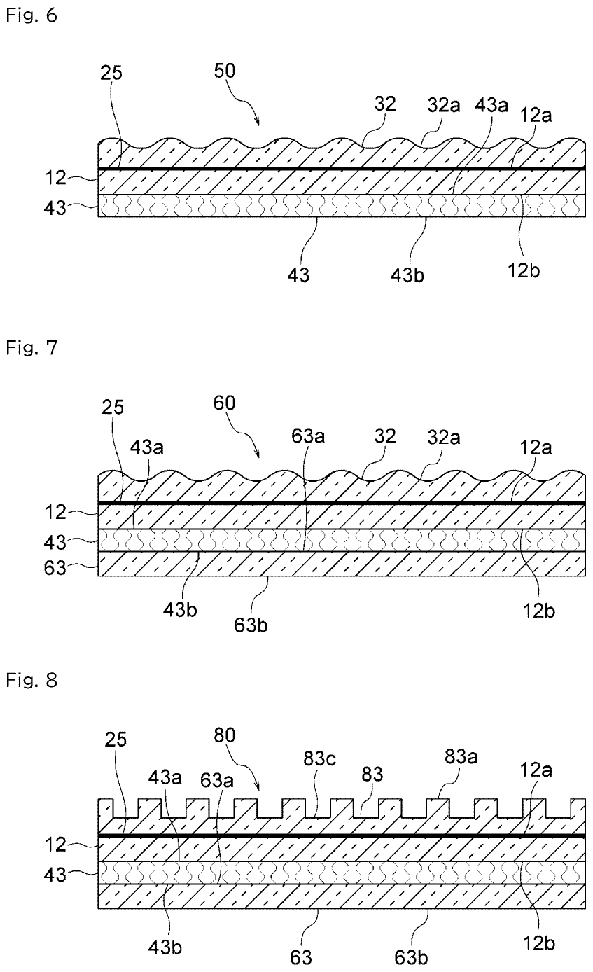

Next, as shown in FIG. 6, a conveyance belt 50 according to a fifth embodiment in which a conductive resin layer is not provided on the back surface 43b of the knitted fabric 43 will be described. In the conveyance belt 50, the belt body 12 is provided on the front surface 43a of the knitted fabric 43, and the front surface layer 32 is provided on the front surface 12b of the belt body 12 via the conductive resin layer 25.

The knitted fabric 43 may be woven with a conductive yarn to provide conductive properties, or may be woven with a non-conductive yarn to provide non-conductive properties. In the conveyance belt 50, the back surface 43b of the knitted fabric 43 is exposed to the outside, and is in contact with the pulley.

According to the above configuration, the conveyance belt 50 according to the fifth embodiment can exert the Same effects as those in the above first embodiment, and the stretchability due to the knitted fabric 43 can also be provided.

As another embodiment of the above fifth embodiment, as shown in FIG. 7, a conveyance belt 60 may be provided in which a back surface layer 63 is further provided on the back surface 43b of the knitted fabric 43. In this case, the conveyance belt 60 includes the front surface layer 32, the conductive resin layer 25, the belt body 12, the knitted fabric 43, and the back surface layer 63.

The back surface layer 63 has the knitted fabric 43 provided on a front surface 63a of the back surface layer 63. In the back surface layer 63, a back surface 63b of the back surface layer 63 is exposed to the outside, and the pulley is in contact with the back surface 63b. The back surface layer 63 is desired to be formed from the same material as the belt body 12 (a thermoplastic resin having a glass transition temperature of −30 °C or lower, such as an ether-based thermoplastic polyurethane resin). However, the back surface layer 63 may also be formed from a material different from the material of the belt body 12, such as a thermoplastic resin having a glass transition temperature of −30 °C or lower, such as an ether-based thermoplastic polyurethane resin containing an ion conducting material or conductive filler. In the conveyance belt 60, the knitted fabric 43 may have conductivity.

The conveyance belt 60 can be manufactured by any method as long as this method does not cause the front surface layer 32, the conductive resin layer 25, the belt body 12, the knitted fabric 43, and the back surface layer 63 to separate from each other. As described above, the conductive resin layer 25, the belt body 12, the knitted fabric 43, and the back surface layer 63 are bonded under heating and pressurizing conditions, a resin for forming the front surface layer 32 is extruded onto the conductive resin layer 25, and then pressed by a basis weight roll to manufacture the conveyance belt 60.

According to the above configuration, the conveyance belt 60 shown in FIG. 7 can exert the same effects as those in the above first embodiment, and the stretchability due to the knitted fabric 43 can also be provided.

The surface roughness Rz specified in JIS B0601 of the conveying surface 32a of the front surface layer 32 exposed to the outside may be more than 100 μm and 1000 μm or less, or may be 100 μm or less.

### Sixth Embodiment

FIG. 8 is a cross-sectional view showing a configuration of a conveyance belt 80 according to a sixth embodiment in which a plurality of vertical grooves 83c are provided on a conveying surface 83a of a front surface layer 83 along a longitudinal direction. The conveyance belt 80 includes the front surface layer 83, the conductive resin layer 25, the belt body 12, the knitted fabric 43, and the back surface layer 63. In this case, the vertical grooves 83c in which a recess extends in the longitudinal direction (conveying direction) of the conveyance belt 80 are formed on the conveying surface 83a of the front surface layer 83. A plurality of vertical grooves 83c are formed at predetermined intervals in a width direction perpendicular to the longitudinal direction.

For example, the conductive resin layer 25, the belt body 12, the knitted fabric 43, and the back surface layer 63 are integrated in a manner of preventing peeling, and then a resin for forming the front surface layer 83 is extruded onto the conductive resin layer 25, and the resin is pressed on the conductive resin layer 25 by a basis weight roll to manufacture the conveyance belt 80. The front surface layer 83 including the plurality of vertical grooves 83c can be formed on the front surface 83a by the basis weight roll.

According to the above configuration, the conveyance belt 80 according to the sixth embodiment can exert the Same effects as those in the above first embodiment, and the stretchability due to the knitted fabric 43 can also be provided. Furthermore, in the conveyance belt 80, the plurality of vertical grooves 83c are formed on the conveying surface 83a of the front surface layer 83, and thus, the irregularities formed by the vertical grooves 83c on the conveying surface 83a can further improve the gripping property of the object to be conveyed. By forming a plurality of vertical grooves 83c along the longitudinal direction on the conveying surface 83a of the conveyance belt 80, the object to be conveyed is difficult to move in the width direction of the conveyance belt 80, thereby further improving the gripping property in the width direction.

A conveyance belt may be provided in which the vertical grooves 83c along the longitudinal direction as shown in FIG. 8 are provided on the conveying surface of the front surface layer 32 of each of the conveyance belts 30 and 50 shown in FIG. 4 and FIG. 6. In the above sixth embodiment, a case where the vertical grooves 83c are provided along the longitudinal direction on the conveying surface 32a of the front surface layer 32 provided on the front surface 12a of the belt body 12 is described, but the present invention is not limited thereto. As shown in FIG. 3 and FIG. 5, when the belt body 12 does not have a front surface layer on the front surface and the belt body 12 itself serves as the conveying surface 22a, the vertical grooves 83c along the longitudinal direction may be provided on the conveying surface 22a of the belt body 12.

### Seventh Embodiment

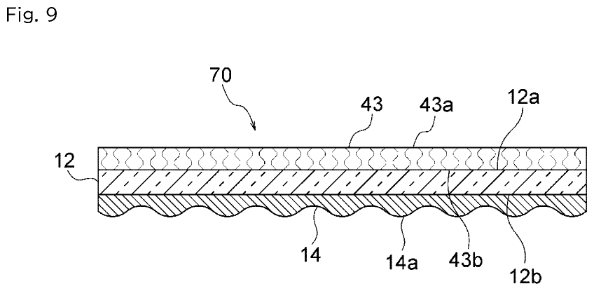

FIG. 9 is a cross-sectional view showing a configuration of a conveyance belt 70 according to a seventh embodiment which includes the knitted fabric 43, the belt body 12, and the conductive resin layer 14. The conveyance belt 70 has the knitted fabric 43 on the front surface 12a of the belt body 12, and has the conductive resin layer 14 on the back surface 12b of the belt body 12. In this case, a front surface of the knitted fabric 43 of the conveyance belt 70 serves as a conveying surface 43a. In the conveyance belt 70 according to the present embodiment, the front surface of the knitted fabric 43, which has a low coefficient of friction (μ), serves as the conveying surface 43a, and thus the conveying surface 43a can be made low-μ. The knitted fabric 43 has the same configuration as the knitted fabric 43 of the above fourth embodiment, but may be made of either conductive yarn or non-conductive yarn.

Here, for example, in an accumulation conveyor that accumulates objects to be conveyed on the conveyance belt 70 or a skew conveyor that aligns objects to be conveyed toward an end portion of the conveyor, the objects to be conveyed have to slide on the conveying surface 43a, and the conveying surface 43a is desired to have a low coefficient of friction. Therefore, the conveyance belt 70, which can make the conveying surface 43a low-μ using the knitted fabric 43, is an appropriate belt for use in the accumulation conveyor and the skew conveyor. Similarly to the above embodiments, the conveyance belt 70 can be manufactured by any method as long as this method does not cause the knitted fabric 43, the belt body 12, and the conductive resin layer 14 to peel off from each other.

According to the above configuration, the conveyance belt 70 according to the seventh embodiment, similar to the first embodiment described above, can maintain the flexibility without hardening even in the low-temperature environment of −30 °C or lower, the possibility of damage to the motor and the pulley of the conveying facility can be reduced, and the object to be conveyed can be stably conveyed. The conveyance belt 70 uses the front surface of the knitted fabric 43 as the conveying surface 43a, thereby reducing the coefficient of friction of the conveying surface 43a, and thus the conveyance belt 70 can also be used in the accumulation conveyor or the skew conveyor in the low-temperature environment of −30 °C or lower.

### Eighth Embodiment

In the first embodiment to the seventh embodiment described above, the conveyance belts 10, 20, 30, 40, 50, 60, 70, and 80 are described, but the present invention is not limited thereto, and may also be applied to a power transmission belt having conductivity. The power transmission belt is a belt that does not convey an object to be conveyed, but transmits power to a pulley or the like in a power facility to drive the pulley to rotate. In this case, the power transmission belt has the belt body 12 made of a thermoplastic resin having a durometer hardness A of 85 or less as specified in JIS K7311 at −30 °C. Accordingly, even in the power transmission belt, since the belt body 12 has a durometer hardness A of 85 or less at −30 °C, the flexibility can be maintained without hardening even in the low-temperature environment of −30 °C or lower, and a possibility of damage to a motor and a pulley of a power facility can be reduced.

Each of the conveyance belts 10, 20, 30, 40, 50, 60, 70, and 80 according to the first embodiment to the seventh embodiment can be used as power transmission belts, and the detailed configuration or the like of the power transmission belts corresponding to each of the embodiments may be described by simply replacing the term “conveyance belt 10, 20, 30, 40, 50, 60, 70, or 80” in the first embodiment to the seventh embodiment described above with “power transmission belt”. The detailed description is omitted here to avoid repetition, but the outline is as follows.

The belt body 12 of the power transmission belt has a durometer hardness A of 75 or more as specified in JIS K7311 at 23 °C. The power transmission belt has the conductive resin layer 14 laminated on the belt body 12. The front surface 12a of the belt body 12 of the power transmission belt is desired to have a surface roughness Rz specified in JIS B0601 of 15 μm or more and 100 μm or less. However, the conveying surface 12a of the belt body 12 of the power transmission belt or the conveying surface 32a of the front surface layer 32 provided on the front surface 12a of the belt body 12 may have a surface roughness Rz specified in JIS B0601 of more than 100 μm and 1000 μm or less.

As shown in FIG. 5 to FIG. 9, the power transmission belt may have the knitted fabric 43 laminated on the belt body 12. As shown in FIG. 5, the power transmission belt may have the knitted fabric 43 on the back surface 12b of the belt body 12, and the conductive resin layer 14 on the back surface 43b of the knitted fabric 43. As shown in FIG. 7 and FIG. 8, the power transmission belt may have the knitted fabric 43 on the back surface 12b of the belt body 12, and the back surface layer 63 made of a thermoplastic resin having a durometer hardness A of 85 or less as specified in JIS K7311 at −30 °C on the back surface 43b of the knitted fabric 43. As shown in FIG. 9, the power transmission belt may have the knitted fabric 43 on the front surface 12a of the belt body 12. The power transmission belt may have the vertical groove 83c formed along the longitudinal direction on the conveying surface 22a of the belt body 12 or on the conveying surface 32a of the front surface layer 32 formed on the front surface 12a of the belt body 12.

### REFERENCE SIGN LIST

10, 20, 30, 40, 50, 60, 70, 80 conveyance belt (power transmission belt)
12 belt body
12a, 22a, 32a, 43a, 83a conveying surface
14, 25 conductive resin layer
32, 83 front surface layer
43 knitted fabric
63 back surface layer

1. A conveyance belt having conductivity, the conveyance belt comprising:
a belt body made of a thermoplastic resin having a durometer hardness A of 85 or less as specified in JIS K7311 at −30 °C.

2. The conveyance belt according to claim 1, wherein
the belt body has a durometer hardness A of 75 or more as specified in JIS K7311 at 23 °C.

3. The conveyance belt according to claim 1, further comprising:
a conductive resin layer laminated on the belt body.

4. The conveyance belt according claim 1, wherein
a conveying surface of the belt body has a surface roughness Rz specified in JIS B0601 of 15 μm or more and 100 μm or less.

5. The conveyance belt according to claim 1, wherein
a conveying surface of the belt body or a conveying surface of a front surface layer provided on a front surface of the belt body has a surface roughness Rz specified in JIS B0601 of more than 100 μm and 1000 μm or less.

6. The conveyance belt according to claim 1, further comprising:
a knitted fabric laminated on the belt body.

7. The conveyance belt according to claim 1, wherein
the belt body, a knitted fabric, and a conductive resin layer are laminated.

8. The conveyance belt according to claim 1, further comprising:
a knitted fabric on a back surface of the belt body; and
a back surface layer made of a thermoplastic resin having a durometer hardness A of 85 or less as specified in JIS K7311 at −30 °C and provided on the back surface of the knitted fabric.

9. The conveyance belt according to claim 1, further comprising:
a knitted fabric on a front surface of the belt body.

10. The conveyance belt according to claim 1, wherein
a vertical groove is provided along a longitudinal direction on a conveying surface of the belt body or a conveying surface of a front surface layer provided on a front surface of the belt body.

11. A power transmission belt having conductivity, the power transmission belt comprising:
a belt body made of a thermoplastic resin having a durometer hardness A of 85 or less as specified in JIS K7311 at −30 °C.
